(19) United States
(12) Patent Application Publication
(10) Pub. No.: US 2015/0220643 A1
(43) Pub. Date: Aug. 6, 2015

(54) SCORING PROPERTIES OF SOCIAL MEDIA POSTINGS

(71) Applicant: INTERNATIONAL BUSINESS MACHINES CORPORATION, Armonk, NY (US)

(72) Inventors: Alfredo Alba, Morgan Hill, CA (US); Clemens Drews, San Jose, CA (US); Daniel Gruhl, San Jose, CA (US); Neal R. Lewis, San Jose, CA (US); Meenakshi Nagarajan, San Jose, CA (US)

(73) Assignee: INTERNATIONAL BUSINESS MACHINES CORPORATION, Armonk, NY (US)

(21) Appl. No.: 14/169,695

(22) Filed: Jan. 31, 2014

(51) Int. Cl. G06F 17/30

(52) U.S. Cl. CPC G06F 17/30867

(57) ABSTRACT

Embodiments of the present invention relate to scoring of messages published to digital media based on past performance of similar messages. In one embodiment, an input token is received. A plurality of messages is selected from a corpus of messages. Each of the plurality of messages has a publication time and contents. The contents of each of the plurality of messages include the input token. A plurality of root messages is determined from the plurality of messages. Each of the plurality of root messages relates to at least one related message. The at least one related message is one of the plurality of messages. Each of the plurality of root messages is the earliest message of the corpus of messages related to its at least one related message. A score is determined for the input token based on the plurality of root messages.

### BACKGROUND

Embodiments of the present invention relate to scoring of messages, and more specifically, to scoring of messages published to digital media based on past performance of similar messages.

### BRIEF SUMMARY

According to one embodiment of the present invention, a method of and computer program product for scoring properties of social media postings are provided. An input token is received. A plurality of messages is selected from a corpus of messages. Each of the plurality of messages has a publication time and contents. The contents of each of the plurality of messages include the input token. A plurality of root messages is determined from the plurality of messages. Each of the plurality of root messages relates to at least one related message. The at least one related message is one of the plurality of messages. Each of the plurality of root messages is the earliest message of the corpus of messages related to its at least one related message. A score is determined for the input token based on the plurality of root messages.

### BRIEF DESCRIPTION OF THE SEVERAL VIEWS OF THE DRAWINGS

FIG. 1 depicts an exemplary user interface for a prescriptive system for iterative content refinement according to embodiments of the present disclosure.

FIGS. 2a and 2b depict the importance of individual features in a Random Forest model according to an embodiment of the present disclosure.

FIG. 3 depicts the distribution of follower counts according to an embodiment of the present disclosure.

FIG. 4 depicts predictive performance according to embodiments of the present disclosure.

FIGS. 5a and 5b depict the relationship between repost count and RingScore according to embodiments of the present disclosure.

FIG. 6 depicts a computing node according to an embodiment of the present invention

### DETAILED DESCRIPTION

It is estimated that 72% of online adults use social media sites. This percentage is even higher within the subgroup of young adults. In addition, the presence of senior citizens has roughly tripled in recent years. As the usage of social networking websites become routine for adults of all ages, these platforms represent an ever increasing opportunity for content sharing for virtually any content-producing professional or institution. With the increasing volume of communication through social media, organizations have an increasing need to use various social media as venues for public communication. With public communication arises the need for a public communications strategy.

Authoring popular content for social media is challenging, especially considering the many variables that contribute to the “uptick” of a message. The presence or absence of attribution can largely dictate how repostability (retweetability in the context of microblogging) is observed in a diffusion network. Negative sentiment enhances virality in the news segment, but not in the non-news segment. Of these many attributes that enhance a message's tendency to propagate, word choice is the one controllable at the time of writing.

Given language variation among different demographics and communities, word choice impacts an audience's reception of content. This variation is quite pronounced in the “New Media” age. For instance, the word choice of middle age professionals discussing their product goals differs from teenage students discussing their music interests. This highlights a fundamental reason why word choice is important: by speaking the wrong vernacular one can not only distort the core of a message but also its reach.

While writing, it may be particularly difficult to predict how effective the terminology used in a message will be, particularly with respect to how much it will picked up by social media participants and how far and for how long the message will propagate in a community. There thus exists a need in the art both for accurate scoring methods that provide an understanding of messaging strategies and how they relate to their target audience. In particular, there is a need for scoring that considers the “reverberation” of such communication as a measure of effectiveness in social media. Furthermore, there is a need for user interfaces and devices that leverage scoring systems to provide a user the ability to efficiently craft messages that are likely to reverberate best with a target audience.

According to various embodiments of the present disclosure, systems and methods are provided that measure the effectiveness of social media messages and enable a user to progressively refine word choice and language to create more effective messaging. According to various embodiments of the present disclosure, an editor is provided that allows an author to modify their word choices to increase their repostability (retweetability in the context of microblogging). Using metrics computed for a message and its component words and phrases, an editor is provided that highlights potentially ineffective constructs and suggests alternatives. In this manner, a user may efficiently craft messages that are likely to reverberate best with a target audience. A range of relevant metrics are provided to a user, presented in a unified console. Scoring system such as those disclosed herein may be used both to predict properties of a social media message, and to guide a user in creating the most effective message.

According to various embodiments of the present disclosure, a measure called RingScore is provided to prescribe word changes for an uptick in retweetability. RingScore estimates how well the language used in a microblogging post such as a tweet has performed, based on the observation of past data. Certain words may ‘ring’ or ‘sound’ better within a community. Based on this sound-related metaphor, a measure is provided of how ‘loud’ a word sounds, how prevalent it sounds within a time period, and for how long it sounds.

RingScore may be used in realtime to measure the effectiveness of social media messages and enable a user to progressively refine word choice and language to create more effective messaging. Various examples below focus on individual words in a microblogging post such as a tweet. However the present disclosure is applicable to n-grams of any length and to other kinds of data such as email, blogs, and news articles.

### Message Editor

Using metrics computed for a message and its component words and phrases, an editor is provided that highlights potentially ineffective constructs and suggests alternatives. In this manner, a user may efficiently craft messages that are likely to reverberate best with a target audience. A range of relevant metrics are provided to a user, presented in a unified console. Scoring system such as those disclosed herein may be used both to predict properties of a social media message, and to guide a user in creating the most effective message.

Crafting a message that will resonate well with a specific target audience requires not only an appreciation for the content of the message being conveyed but also empathy for the emotion expressed by word choice and grammar. It is common for a single communications professional to craft messages for multiple venues. In such circumstances, there is a need for tools that help a user adopt the appropriate language for a particular client. The systems and methods of present disclosure may be used for iterative refinement of a message via substitution of words and phrases. Immediate quantifiable feedback may be provided indicative of the “resonance” within a target community. Additionally, word or phrase modifications may be automatically suggested to maximize the resonance of the target message based on tunable criteria. Accordingly, the systems and methods of the present disclosure may be used as a research tool for discovering previously unknown messaging trends, to provably reinforce existing notions of message fitness, and to reduce or even obviate much of the need for focus groups and other time and resource intensive alternative methods.

The systems and methods of the present disclosure are language-independent. The editor of the present disclosure may be used with a variety of metrics including the scoring methods described further herein. However, metrics may additionally be based on tweet similarity, readability score, auto-complete, demographics, and stylistic differences with other twitter users. In some embodiments, the editor uses subject matter expert feedback to determine the most effective replacement words or phrases rather than automatically changing words or phrases. In other embodiments, words and phrases are automatically substituted without user intervention.

The editor allows users to progressively refine messaging to optimize their potential to be well received by a target audience based on quantifiable and tunable criteria. The editor uses a corpus of language samples from the intended target audience. This corpus is augmented with scores for its content. In some embodiments, a user enters a draft message into the text editor. The editor provides feedback on the potential effectiveness of each individual token or word and a total effectiveness score. In various embodiments, feedback includes: a score of a token, word, or phrase; valence of content containing a token, word, or phrase; visualization of the score (e.g., a time histogram with sub scores); the best pronunciation for the target audience; or the most effective word choice for a target audience. Feedback for the entire message may be based on: the total score; the total valence; a sentiment score; or a readability score. The editor may provide to the user alternatives for each word or token. In various embodiments, these alternatives are based on a thesaurus or dictionary. In some embodiments, dictionaries are created via a dictionary creation tool such as Glimpse, which is disclosed in commonly invented and assigned patent applications. After each modification of the message, the modified message is again augmented with feedback on its effectiveness inclusive of the modifications.

In some embodiments, the corpus used for scoring may vary between feedback on individual words, feedback on the entire message, and suggestion of alternatives. In addition, the corpus may vary between successive applications of each of the above steps. For example, one corpus may be used to score according to how an entity talks about itself, while another may be used to score according how an entity is talked about by others.

In some embodiments, once a user is satisfied with a modified message, the editor provides the ability to submit the message to a destination. For example, the editor may allow posting to Twitter, Facebook, LinkedIn, a blog, a CMS, or other social media outlet or webpage.

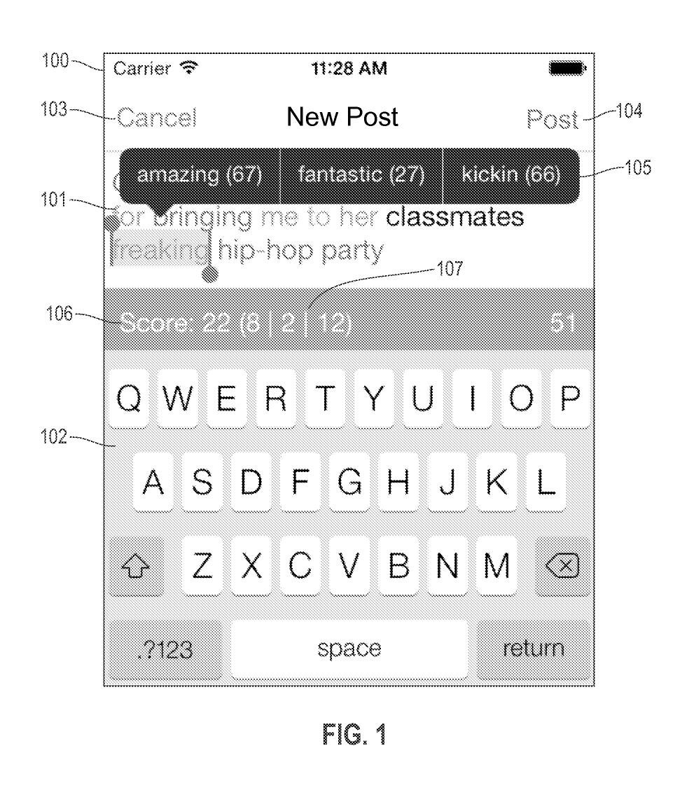

With reference now to FIG. 1, an exemplary user interface for a text editor is depicted according to embodiments of the present disclosure. User interface 100 comprises a text input area 101, a keyboard 102, a cancel button 103 and a send button 104. A user enters words into text input area 101 via keyboard 102. As the potential message (e.g., a microblogging post such as a tweet) is entered, the RingScore of each word is dynamically computed. Words with scores below a threshold value are colored to suggest that higher scoring words are available. Selecting an individual word from text area 101 reveals a contextual menu 105. Contextual menu 105 provides alternatives to the selected word with their respective RingScores (parenthetically). The user may then choose from the suggested substitutes or enter an alternative. The substitute selected by the user replaces the selected word in text area 101.

Upon selection of a word, the score 106 of that word is displayed, enabling comparison with the scores of each potential replacement in menu 105. In some embodiments, the volume, prevalence and sustain components 107 of score 106 are included parenthetically.

The user interface 100 is useful for social media communication professionals to tailor messages to varied audiences. As an example, a teenager and a middle aged person may both be trying to write a post thanking a friend for introducing them to people in a social situation. These two social groups are distinctly different with respect to common diction.

The teenager's tweet may be “give a shoutout to my awsome BFF for bringing me to her classmate's kickin* hip-hop party” while the middle aged person may tweet “thanks to my social guru for helping me shamelessly network at the xfactor party—mucho appreciated”. In both examples, those non-stop words that particularly resonate (i.e., have a high RingScore) with each target audience are underlined. Both of these authors reflect (or understand) their target audiences and are writing appropriately. The first tweet even includes the common misspelling of awesome from the relevant peer group. Several of the words they are using have very good RingScore and none of them are particularly poor choices.

However, had the tweets been reversed, and instead sent to the other target peer group, the scores would vary appreciably. In this case, particularly poor words (those with a low RingScore) are underlined: “thanks to my social guru for helping me shamelessly network at the xfactor party—mucho appreciated”. Many of the “good” words for the older target audience are just average with this one, and a number of the words have poor RingScores and thus are likely to not “ring” well for the younger audience. Similarly, language from the “younger” diction would ring poorly for an older audience: “give a shoutout to my awsome BFF for bringing me to her classmate's kickin hip-hop party”. Again, this language would likely not resonate very well with the other peer group. This ability to analyze microblogging posts such as tweets for a particular audience provides the opportunity to do “synthetic market studies” of every post looking at a specific target audience.

The “prescriptive” nature of RingScore allows a system to coach an author into considering potentially better word choice in their posts. One challenge to tailoring of a message is that microblogging platforms such as Twitter are especially targeted as mobile “as it happens” platforms. Accordingly, in order to impact this space there is a need to present an analysis of a potential post on a mobile device. Such an application should allow the user to identify poor “ringing” words and consider synonyms (e.g., from a thesaurus) that have better RingScore. It should present the user with above or below average “ring” indications for each word in the message as it is currently written.

In one embodiments of the present disclosure, the user interface 100 of FIG. 1 may be used as a simple microblogging posting client. In some embodiments, the user interface runs on iOS, and allows a user to type a proposed post (given a target audience), and get a real time estimate of how well it will resonate.

The design of user interface 100 is guided by the themes of Deference, Clarity and Depth. The user interface helps the user to understand and interact with the content, without competing with it. Text is legible at every size, icons are precise and lucid, adornments are subtle and appropriate, and a sharpened focus on functionality motivates the design. Visual layers and realistic motion impart vitality and heighten users' delight and understanding. More specifically, the user interface provides immediate feedback on the effectiveness of a post while composing it, displays the RingScore for each word and the complete post, provides detailed RingScores for individual words, presents the user with a list of synonyms with higher RingScores to replace a word with a low score, and follows established interaction patterns of the platform (e.g., of iOS).

The user interface makes use of color to show the RingScore for each word as well as for the overall post to provide the user with an immediate understanding of the effectiveness of each word in the post. Additionally, the overall RingScore for the post is shown in numerical representation, as is the number of characters remaining from the 140 character limit that is customary for a microblogging post.

Tapping a word twice highlights the word and provides the detailed Ring score for the selected word. If synonyms are available they are presented in a context menu layered above or beyond the selected word. Tapping one of the synonyms replaces the selected word with the selected synonym. A context menu provides a familiar interaction pattern for text manipulation on, e.g., the iOS platform.

Referring back to the example depicted in FIG. 1, the user interface indicates to the user that “amazing” has a slightly higher “ring” than “freaking”. However, the user may select that slightly lower scoring “kicken” if they feel that it is more suitable to the context. In this way, RingScore may be used to provide suggestions while a user is responsible for adopting the most comfortable phrasing.

### Scoring Algorithm

Within social networks, certain messages propagate with more ease or attract more attention than others. This effect can be a consequence of several factors, such as topic of the message, number of followers, real-time relevance, and the person who is sending the message. Only one of these factors is within a user's reach at authoring time: how to phrase the message. According to embodiments of the present disclosure, methods are provided for determining how word choice contributes to the propagation of a message.

A prescriptive model is provided that analyzes words based on their historic performance in reposts (retweets in the context of microblogging) in order to estimate future tweet performance. The model calculates a RingScore that is built on three aspects of diffusion—volume, prevalence and sustain. This model accounts for network effect and allows different outcomes based on alternative repostability (or retweetability) facets.

RingScore has powerful predictive ability, and it complements social and post-level features to achieve an F1 score of 0.82 in repost prediction. Moreover, it has the ability to prescribe changes to the tweet wording such that when the RingScore for a post is higher, it is twice as likely to have more reposts.

This prescriptive model may be used to assist users in content creation for optimized success on social media. Because the model works at the word level, it may be integrated into user interfaces which help authors incrementally—word by word—refine their message until its potential is maximized and it is ready for publication. Although discussed below in the context of a mobile application, it will be apparent that the present disclosure is applicable to other digital devices.

The RingScore may be defined as an operation on a set of artifacts (S) which are associated with a measure of how often they are attracting attention (e.g., retweets, reply comments), the date that they occur, and the time that the attention is attracted (e.g., retweet date, comment date).

In some embodiments, the RingScore algorithm comprises the steps of: selecting a set of historical posts and extracting a few pieces of meta data; and combining all of these into a single RingScore. A word or attribute is selected for evaluation. Although words are used as examples herein, the present disclosure is applicable to other attributes of a message, such as author, class of influencers, time of tweet, or geographic location of tweet. Similarly, the present disclosure is applicable to n-grams in addition to single words. From the corpus of posts defining a target audience, all posts are selected that mention the selected word or bear the selected attribute. Each of these posts is examined to determine a root tweet. The root post is the post that was the initial source of all further reposts (or retweets). The time of the root post is determined. Reposts of the root post are analyzed to determine the frequency with which the root post was reposted and to determine for how long reposting continued. The RingScore is defined as an operation on this set of artifacts and meta-data.

In some embodiments, the RingScore is calculated as a combination of three sub scores that are analogous to the properties of sounds. In particular, given a word, how well will it sound in the social network in terms of: Volume, Prevalence, Sustain.

Let D be a subset of artifacts of size n=[D], selected via the mechanism above from a universe (e.g., tweets) as a representative sample of a community c. Hereafter, D(w) is used as the shorthand notation for the subset of all artifacts in D that contain the word w.

D(w)={∀tᵢεtokenize(tᵢ)}

Let RT(t) be the observed repostability of a post t where RT(t) is the number of times a post has been forwarded by a user through a repost function, such as the retweet function on Twitter. Let two sets of artifacts be defined based on their repostability. Namely, let NZRT (non-zero retweets) be the set of reposted artifacts, and ZRT (zero retweets) be the set of non-reposted artifacts. Similarly, we define shorthand notations for the sets of reposted artifacts and non-reposted artifacts containing the word w, respectively. These sets are used to compute estimates of RingScore components. NZRT and ZRT are defined below.

NZRT(w)={tᵢεD(w)|RT(tᵢ)>0}

ZRT(w)={tᵢεD(w)|RT(tᵢ)=0}

Volume of a word w captures the intuition of how ‘loud’ w rings in the subset of artifacts. It is represented by the sum of the repost counts of all artifacts in D(w) that have a non-zero repost count. Volume (V) is defined below.

$$V ( w ) = {\sum }_{∀ {t}_{i} ∈ NZRT ( w )} RT ( {t}_{i} )$$

Amplitude of a word w is a variant of Volume that models the difference in volume for a word w in a subset of posts that were reposted versus a subset of posts that were not reposted. Amplitude (A) is defined below, where φ(xεX)=x−mean(X) is a mean-centering transformation function to center the counts around 0.

A(w)=φ(|NZRT(w)|)−φ(|ZRT(w)|)

Prevalence captures the notion that some words are more common than others over a timespan of interest. It is computed based on the number of elements in D(w) that occur for each day in the timespan {τ−, τ+} of interest. Prevalence (P) is defined below.

$$P ( w ) = {\sum }_{d ∈ \{ τ - , τ + \}} DC ( w , d )$$

The daily count DC(w, d) is the cardinality of the set of artifacts tᵢ in day d that contain the word w.

DC(w,d)=|{∀tᵢεD(w)|date(tᵢ)εd}|

Sustain of a word captures the notion of how long a word rings in a subset. The score rₛ is defined as the sum of the number of hours from first to last tweet of all tᵢ where this number is non-zero.

$$S ( w ) = {\sum }_{\{ ∀ {t}_{i} ∈ D ( w ) \vert HR ( {t}_{i} ) > 0 \}} HR ( {t}_{i} )$$

The number of hours (HR) is calculated from the first time a post id appeared in the dataset, until the last time it appeared.

Based on the word-level scores V(w), P(w) and S(w) defined above as functions over words (i.e., functions of the type g:w→ [symbol] ), a post score may be defined. A corresponding score V_{ƒ}(t) is defined as an aggregation of word scores V(wᵢ) for a post t={wᵢ, . . . , wₙ} according to an aggregation function ƒ:{x₁, . . . ,xₙ}ε [symbol] → [symbol] . Corresponding definitions of aggregation functions apply to P_{ƒ}(t) and S_{ƒ}(t).

A possible choice for ƒ is the mean of all individual word scores, capturing the notion that low-score words can be compensated by high-score words. For the purposes of illustration, a three word phrase t₁ is provided below.

t₁={w₁:Winter,w₂:is,w₃:cold}

Assuming that V(w₁)=1, V(w₂)=5, V(w₃)=6, the mean volume score for this example would then be Vₘₑₐₙ(t₁₎₌4. Defining ƒ(x)=min(x), expresses a constraint for the lowest-scored word of the ones present in the post (e.g., Vₘᵢₙ(t₁)=1). Conversely, one can use the max to model how high is the highest word score. Other options are the sum, to capture the accumulated effects of each word, or stdev to catch the variation between word scores. Thus, corresponding V_{ƒ}, P_{ƒ}, and S_{ƒ} are defined and evaluated for each score and aggregation function combination.

RingScore(t, c) may now be defined for a post t and community c as an estimate of how well the posts's words t={w₁, . . . , wₙ} resonate with the community c. The RingScore of a post is computed through an aggregation of the V_{ƒ}(t), P(t) and S(t) scores based on its words, where α+β+γ=1.

Ring(t)=α·V_{ƒ}(t)+β·P_{ƒ}(t)+γ·S_{ƒ}(t)

Here α, β, and γ are mixture weights to control the influence of each component on the final RingScore, according to the desired outcome. In some embodiments, equal weighting is provided to each component. However, as set forth below, various relative weightings optimize repostability.

In alternative embodiments, Volume, Prevalence and Sustain may be defined as follows.

$$V ( w ) = min ( 33 , 10 * {log}_{10} \frac{{Σ}_{∀ {t}_{i} ∈ NZRT ( w )} RT ( {t}_{i} )}{\vert NZRT ( w ) \vert} )$$

$$P ( w ) = min ( 33 , \frac{{Σ}_{d ∈ \{ τ - , τ + \} ,} 10 * {log}_{10} DC ( w , d )}{\vert \{ τ - , τ + \} \vert} )$$

$$S ( w ) = min ( 33 , \frac{{Σ}_{\{ ∀ {t}_{i} ∈ D ( w ) \vert HR ( {t}_{i} ) > 0 \}} 10 * {log}_{10} HR ( {t}_{i} )}{\vert D ( w ) \vert} )$$

Reposts may be considered as endorsements or amplification of a message. In some circumstances, an author of a tweet may wish to “downtick” the repostability of a message. For example, although bound to report bad news, an author may wish to minimize how well it “rings”. The scoring systems and methods of the present disclosure give authors the ability to be flexible in their messaging, prescribing for low sustain. In these cases it is desirable for the “ring” to reflect the desired outcome.

### Test Results

Success or importance of content on microblogging sites such as Twitter may be measured by the repost count. The repost count may be used to rank tweets by importance or rank authors by influence. The RingScore over words of a post as defined above prescribes more successful (i.e., more repostable) messages. The predictive power of the RingScore is shown by comparing and combining it with others features that impact repostability (e.g., social and tweet features). Given that social features cannot be changed at post authoring time, the prescriptive nature of RingScore may be measured by isolating and evaluating the effect of different RingScore values in yielding a better repostability score for a post.

In an exemplary test, 300M tweets were collected from an unfiltered 1% feed from Twitter over a three month period, with a few days missing due to network connectivity challenges. Detailed statistics on the sample are shown in Table 1.

TABLE 1

| | February | March | April | Total |
|---|---|---|---|---|
| Tweets | 77,980,769 | 123,435,918 | 102,420,016 | 303,836,703 |
| . . . with | 14,574,009 | 24,162,601 | 20,589,915 | >44 MM |
| RTs | | | | |
| . . . first | Feb. 05 | Mar. 01 | Apr. 01 | Feb. 05 |
| date | 08:02:20 | 16:48:34 | 07:00:00 | 08:02:20 |
| . . . last | Feb. 28 | Apr. 01 | Apr. 26 | Apr. 26 |
| date | 06:06:19 | 06:59:59 | 22:32:00 | 22:32:00 |
| Users | 23,392,999 | 30,059,234 | 27,338,662 | 47,132,153 |

To test the predictive nature of RingScore and other features, the sample is split into training and testing sets. An arbitrary point τ in time is chosen (April 01 06:59:59). The data is divided into two sets: Dτ+ and Dτ− with all tweets before and after T, respectively. A total of 3.8% of the tweets in Dτ+ has either been tweeted or retweeted in Dτ−. The remaining 96.2% are unseen tweets in Dτ−.

In order to control for the eventual positive or negative effect that spam may have on the analysis, a set of words that commonly appear in spam messages is collected. Every tweet that contains a word from this list is removed from the dataset. After the spam removal, from an evaluation on 300 tweets, none of the highly retweeted messages (>=1000) were spam, while 3.85% of the mid-retweet and 3.23% of the low-retweet messages were considered to be spam (±5.66, confidence level 95%). The ranges for defining low-, mid- and high-retweets are [0, 10), [10, 1000), [1000, +∞).

A sample of 100,000 tweets from Dτ+ that were written in English is taken. However, the system and methods set out herein are not limited to any particular language. An automated language detection tool such as the open source langid.py may be used to screen for a particular language. In this example, based on an evaluation of a random 100 tweets, 87% were correctly detected as English using automated methods.

Tokenization is performed with a tweet tokenizer that is aware of Twitter entities such as users, URLs and hashtags. Occurrences of users, hashtags and URLs may thus also be treated as “words” for the features computed below.

Three categories of features are evaluated below: social features, tweet-level features and word-level features.

The social features include characteristics related to the Twitter user network and help model a tweet's prior probability of getting retweeted based only on who is tweeting to whom. Here, the number of followers and number of friends of a user are used.

The tweet-level features describe the tweet's a priori likelihood of getting retweeted without looking at the individual words they include or the message they convey. These features include the number of hashtags, number of URLs, number of user mentions and the number of stopwords present in a tweet.

The word-level features (volume, prevalence, and sustain), defined above, focus on the mentions of words in tweets within a period or community of interest. The volume captures how frequently and to what extent tweets containing a word have been retweeted, the prevalence seeks to capture how steadily the word has appeared, and sustain captures for how long a “discussion” continues in which the word appears.

Social and tweet-level features are observations, while word-level features are estimates. For instance, the number of hashtags is counted directly from each tweet being evaluated, and so is the number of followers. However, the word-level features compute scores estimated from past tweets in Dτ−, i.e., not in the Dτ+ set from which the testing examples are sampled.

The datasets are preprocessed, assigning a label of 1 to the tweets where RT(t)>1, and 0 otherwise. Under this experimental setting, different approaches can be compared by their ability to correctly retrieve as many of the retweeted posts as possible (high recall) while making as few classification mistakes as possible (high precision).

The data is divided into training and testing sets, with 80% of the data allocated for training Testing is performed with the remaining 50,000 tweets. Social features and tweet features are directly extracted from each tweet being tested. For the word features, the RingScores are computed from word occurrences in Dτ−, in order to avoid any bias. Three different models are applied for predicting the usefulness of features. In all cases, the models are tested on the same sample from Dτ+.

First, optimal weights are determined to linearly combine the features into a RingScore that optimizes the likelihood that a message will get retweeted. For that purpose, several Generalized Linear Models (GLM) are trained using subsets of the features. GLMs are transparent and friendly for user-interaction—the weights may be displayed as knobs or sliders on an interface, giving the users the freedom to disagree with the model's suggestions.

To explore non-linear combinations of features, Conditional Inference Tree (CIT) models are also trained. CITs learn relationships between features and the retweetability labels by recursively performing binary partitions in the feature space until no significant association between features and the labels can be stated.

Random Forests (RF) models are also included, as they perform well in a multitude of classification tasks. RFs learn a large number of decision trees that can be used as an ensemble to collectively predict the label at classification time. RFs operate as a black box, making it harder to take user input into consideration when tweaking the model.

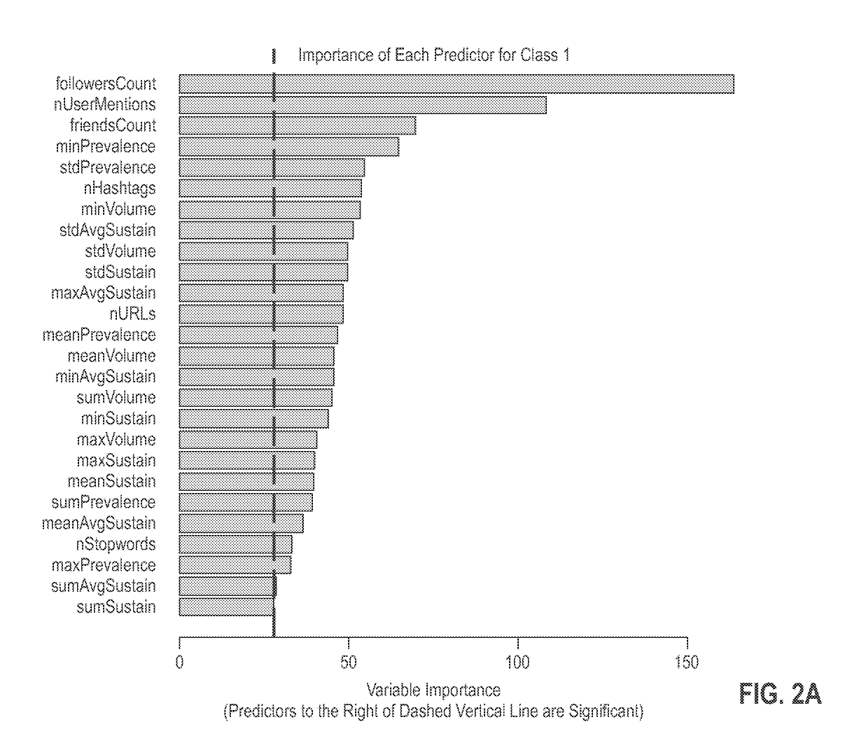

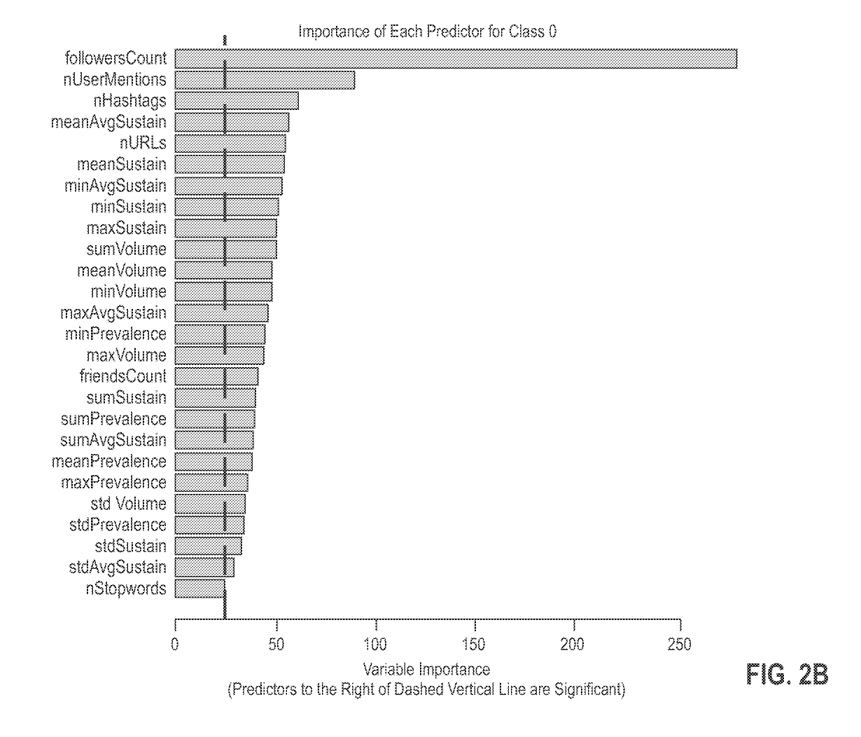

Table 2 shows the performance of each method (rows) in terms of F1 for each of the feature sets (columns). The social features have the best individual group performance, reflecting the intuition that the more popular you are, the more retweets you tend to receive. Tweet features also performed well as a group, indicating that tweets that contain hashtags and URLs are often retweeted. FIG. 2 shows the importance of each feature for the Random Forest model. Out of the scores tested, followers count, user mentions, number of hashtags and number of URLs were the most successful in predicting which tweets were retweeted.

TABLE 2

| | SOC | TWE | SOC + TWE | WOR | ALL |
|---|---|---|---|---|---|
| CIT | 0.71 | 0.70 | 0.73 | 0.59 | 0.74 |
| RF | 0.76 | 0.70 | 0.75 | 0.70 | 0.82 |
| GLM | 0.65 | 0.69 | 0.66 | 0.56 | 0.68 |

The prior probability of a message getting retweeted at all, independently of what one is writing about, depends on how many people will see a particular tweet. A person cannot retweet a post they have not seen. The number of people that see a tweet, in turn, depends on a number of factors. Intuitively, the more followers a user has, the higher the likelihood that their tweets will be seen. One the other hand, hashtags are topic markers that are commonly used for searching, therefore could serve as a way to send the message beyond the stream of followers. Similarly, tweet analysis software may notify users when they are mentioned, which is another way to reach out to users that are not followers. Other features that may impact message visibility include time of the day, trendiness of topic, and other variables.

The high performance of the social and tweet-level features in these results confirms the intuition that targeting a larger audience increases the chances that someone will retweet a message.

Both social and tweet-level features are extracted from the actual tweet being evaluated, while the word-level features are estimated from data from the previous month, i.e., Dτ−. They generalize well over time and offer powerful predictive ability. The best word-level model results are only 0.6 F1 points away from the best social and tweet-level models. Moreover, aggregating the word-level features with social and tweet-level, an increase in 0.06 F1 points is obtained over the best social model, 0.12 over the best tweet-level model and 0.07 over the combination of social and tweet-level features. This demonstrates that word-level features support detecting aspects of a tweet's message that leads to better or worse retweetability.

A prescriptive setting is different from the tweet classification/retrieval setting because when guiding users in formulating tweets to garner higher “uptake”, the choice of features is limited to what can be changed at tweet authoring time. For instance, in this setting the social features are fixed. If users want to achieve higher “uptake”, they cannot easily enhance their social features instantaneously. Similarly, the tweet-level features that performed well in the predictive setting are rather vague in a prescriptive setting. Although we show that tweets with hashtags often get retweeted more, it is unclear from the tweet-level features which hashtags should be used. On the other hand, word-level features may be used to prescribe words (or hashtags) that have shown good historical performance in terms of a particular aspect that the user may want to explore.

The performance of word-level features is isolated and evaluated. First, a prescriptive setting is simulated by investigating the performance of each approach when the social features are fixed and tweet-level features are known. Second, the likelihood that a suggestion given based on the RingScore will yield a higher retweet rate is evaluated.

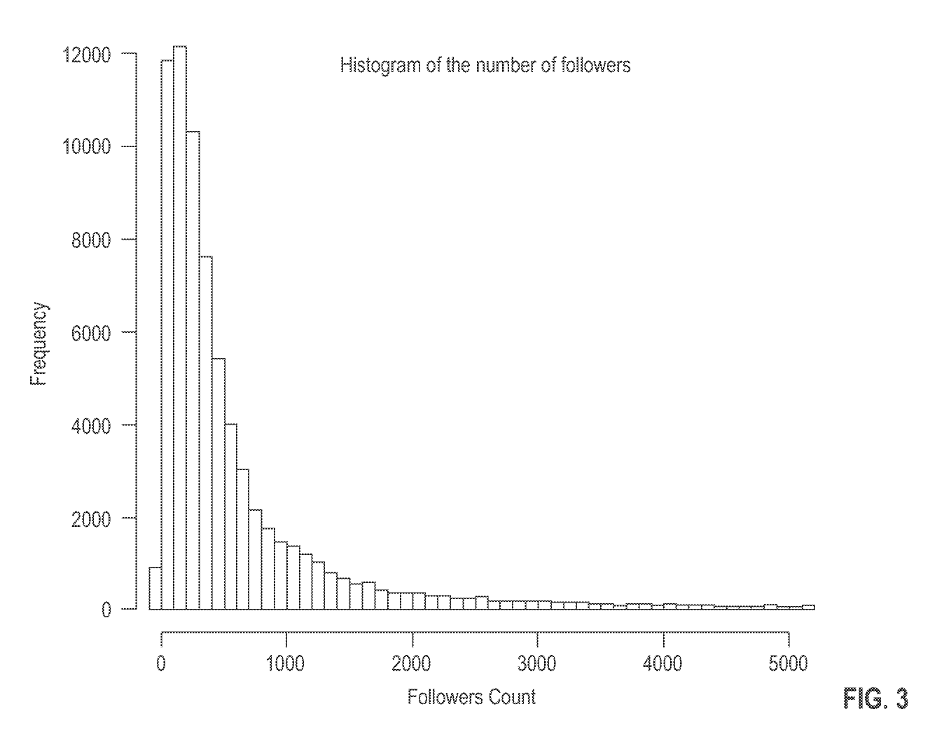

Referring to FIG. 3, a histogram for the number of followers is provided. This histogram shows that a large fraction of users in the sample have between 0-500 followers. Examining a particularly dense area (100-200 followers) shows (see Table 3) the F1 performance of their tweets which contain user mentions. In Table 3, columns refer to social features (SOC), tweet-level features (TWE), word-level features (WOR) and a combination of all features (ALL).

TABLE 3

| | SOC | TWE | WOR | ALL |
|---|---|---|---|---|
| CIT | 0.63 | 0.53 | 0.63 | 0.45 |
| RF | 0.71 | 0.45 | 0.79 | 0.83 |
| GLR | 0.53 | 0.45 | 0.56 | 0.56 |

This simulates a particular prescriptive setting, where a given user may be required to mention someone, while having at that point in time between 100-200 users. Social features lose predictive power in this setting, as their variability decreases. The word-level features, however, not only retain their predictive power but are also prescriptive, allowing an indication of which words in a tweet have a low score.

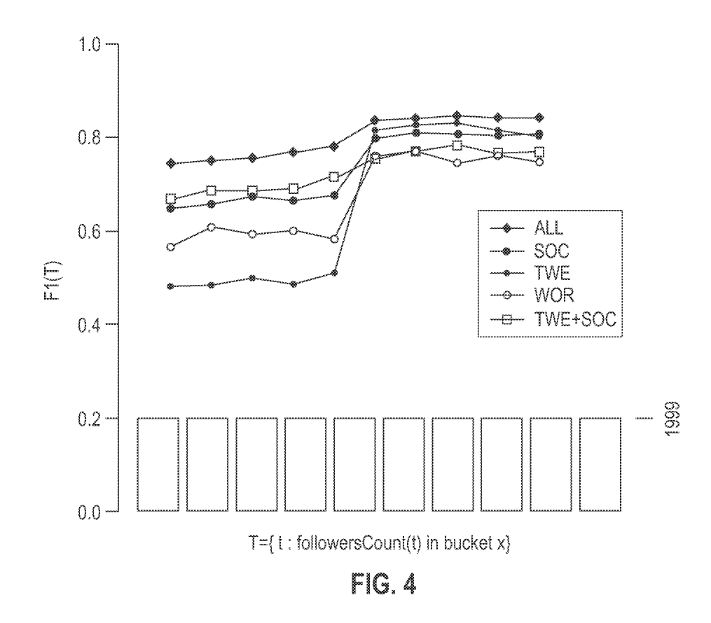

While Table 3 shows a fixed number of followers and user mentions, FIG. 4 shows the performance of each approach across groups of users with distinct follower counts. In FIG. 4, Prediction F1 performance (y) varies with the number of followers (x). Lines represent different feature sets. Bars represent the sizes of each bin. Subsets of data are selected with the same or similar number of followers. For that purpose, the tweets are sorted based on their number of followers. The data is partitioned into 10 bins as follow based on a sweep of the space of followers.

1. {0, 145]

2. (145, 300]

3. (300, 489]

4. (489, 773]

5. (773, 133000]

6. (133000, 373000]

7. (373000, 2430000]

8. (24300, 177000]

9. (177000, 1470000]

10. (1470000, 30100000].

In FIG. 4, each bar on the horizontal axis represents one bin, the left-most indicating bin 1 {0, 145], each containing 2000 tweets. The small vertical axis on the right-hand size of the figure displays the scale of bin sizes.

For users with a large number of followers, it is possible to predict retweetability very well based on social features alone. However, for tweets that were sent to less than 800 followers, closer inspection of content is warranted. In those cases, adding word-level and tweet-level features to the mix significantly increases performance.

A similar effect to the followers count is seen with tweet-level features, which underperforms in tweets with lower number of followers and contributes more for popular users. In all cases, adding word-level features helps increase F1 for all buckets for a given fixed social setting.

How often a prescription from the disclosed system yields enhancements on a tweet's chance to be retweeted may be tested based on a Monte Carlo-style evaluation: 1) For every tweet in a test set, let |RT(t)| be the retweet count (observed) of the tweet, and Ring(t) be the RingScore (prediction) for that tweet; 2) Draw randomly with replacement two distinct tweets from the set, A and B; 3) If Ring(A)>Ring(B), then if Rₜ(A)>Rₜ(B) score 1 point of “good”; 4) If Ring(A)>Ring(B), then if Rₜ(A)<Rₜ(B) score 1 point of “bad”; 5) Repeat this 1 million times.

In essence, this tests the assertion “If the system tells you one tweet is better than the other, what are the odds it is correct”.

Table 4 shows the relative frequency that a ring recommendation yielded an RT improvement. Table 4 may be interpreted as follows: Independent of the number of followers the best individual word-level predictor of retweet is the Volume (prior effectiveness of those words). If combined with hashtags (as discussed above) achieves≈0.65. This value may be thought of as “if the RingScore tells you that tweet A has a better phrasing than tweet B, it will be right twice as often as it is wrong.

TABLE 4

| Model | Feature Sets | P(success) |
|---|---|---|
| CIT | Amplitude, Volume, Prevalence, Sustain, | 72.12% |
| | nURLs, nUserMentions | |
| GLM | Amplitude, Volume, Prevalence, Sustain, | 69.04% |
| | nURLs, nUserMentions | |
| CIT | Amplitude, Volume, Prevalance and Sustain | 68.71% |
| GLM | Amplitude, Volume, Prevalence and Sustain | 66.67% |
| CIT | Volume, nHashtags | 65.44% |

Searching through the space of feature combinations for those that could be used in a prescriptive setting with the highest probability of success yields the results shown in Table 4. In particular, the best performing model relies on Aₘᵢₙ, Aₘₐₓ, Vₘᵢₙ, Vₘₑₐₙ, Vₘₐₓ, Vₛᵤₘ, Pₛᵤₘ, Sₘₑₐₙ, Sₘₐₓ, Sₛᵤₘ, nURLs, and nUserMentions as described above. The formula for the best performing GLM is given below, which obtained a success rate of 0.69. These numbers are skewed by the “social” features not in this prescriptive model—with them included, the predictor goes to≈0.8, or odds are that it will be right four times as often as it is wrong.

0.574·Aₘᵢₙ+1.51·Aₘₐₓ−0.00003·Vₘᵢₙ+0.0002·Vₘₑₐₙ−0.0002·Vₘₐₓ+0.0002·Vₛᵤₘ−0.000005·Pₛᵤₘ−0.002·Sₘₑₐₙ+0.0003·Sₘₐₓ−0.00008·Sₛᵤₘ+1.35·nURLs−0.637·nUserMentions+1.29

There are many factors that impact a tweets “success”, but not unlike a spelling or grammar checker, the disclosed prescriptive model provides an indication of what needs a second look. RingScore helps with finding which tweets will be retweeted, and an increase in RingScore yields an increased probability of being retweeted.

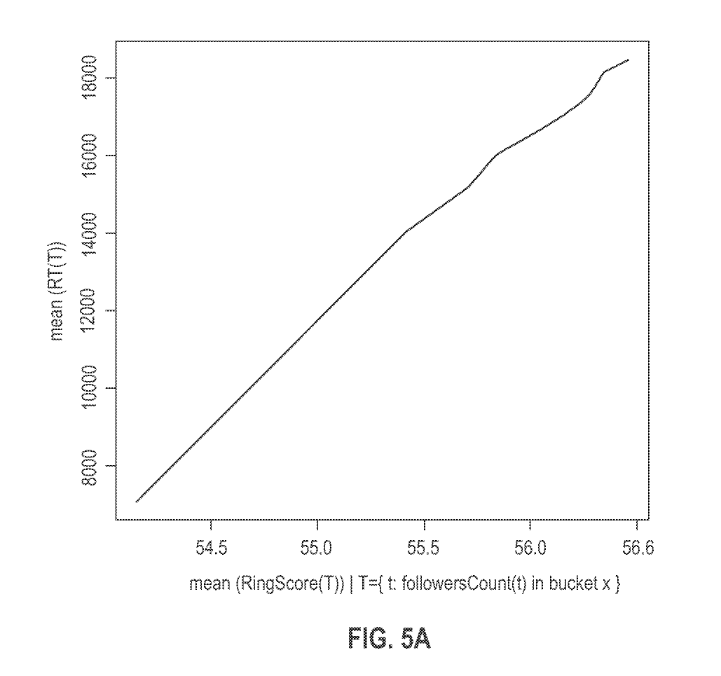

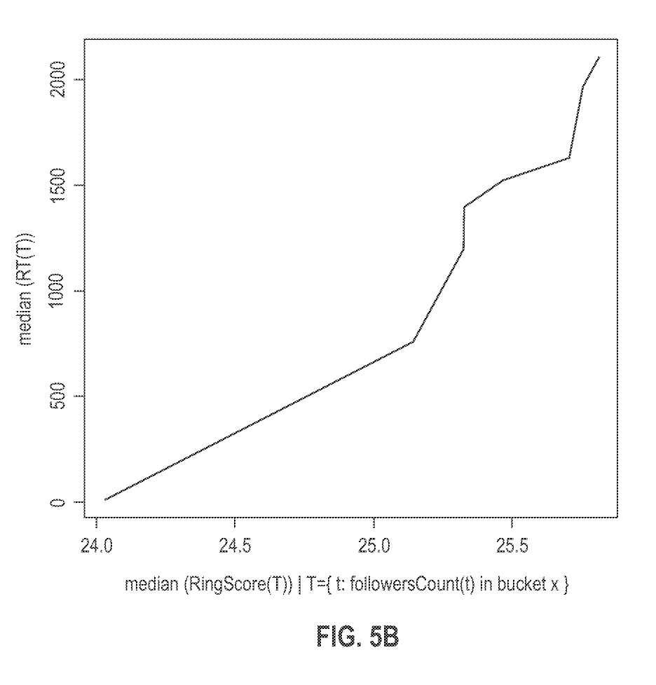

Referring to FIG. 5, the relationship between RingScore and number of retweets is depicted. The data is partitioned into 10 buckets by number of followers. Each point in the line represents averages computed from one of these buckets. On the X-axis is plotted the RingScore and on the Y-axis is plotted the RT count. FIG. 5 shows that an increase RingScore leads to an increase in mean retweet count by bin (FIG. 5a) and median retweet count by bin (FIG. 5b). This does not mean that every time a ring score is higher, the retweet count will also be higher by that amount. As shown above, retweetability depends on a large number of factors. But this analysis shows that, on average, tweets with better ring scores are significantly more successful in their retweetability.

Successful tweet wording examples are also more readable. In particular, maxRing has a correlation with Flesch's Readability Ease (Pearson's 0.11, p-value≈0). Twitter artifacts may influence this result. In particular, the strongest negative correlation with readability is the number of user mentions (−0.27, p-value≈0).

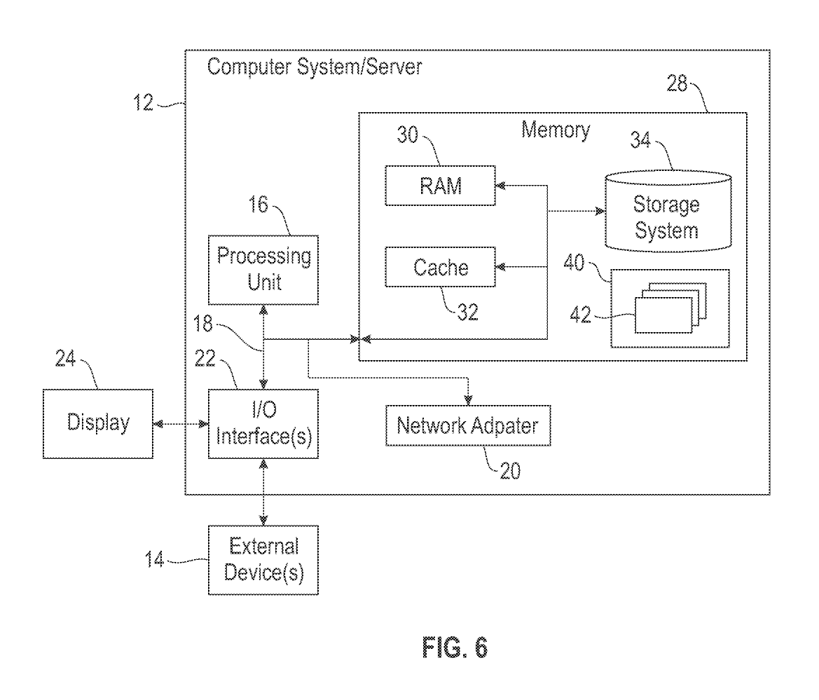

Referring now to FIG. 6, a schematic of an exemplary computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving an input token;
selecting from a corpus of messages a plurality of messages, each of the plurality of messages having a publication time and contents, the contents of each of the plurality of messages including the input token;
determining a plurality of root messages from the plurality of messages, each of the plurality of root messages relating to at least one related message, the at least one related message being one of the plurality of messages, each of the plurality of root messages being the earliest message of the corpus of messages related to its at least one related message; and
determining a score for the input token based on the plurality of root messages.

2. The method of claim 1, wherein determining a score for the input token comprises:
determining at least one feature of each of the plurality of root messages.

3. The method of claim 1, wherein determining a score for the input token comprises:
determining at least one feature of the plurality of root messages and their related messages.

4. The method of claim 1, wherein the at least one related messages of each of the plurality of root messages is a republication of its related root message.

5. The method of claim 1, wherein the at least one related message of each of the plurality of root messages is a forward of its root message.

6. The method of claim 1, wherein the at least one related message of each of the plurality of root messages includes a reference to its root message.

7. The method of claim 3, wherein the at least one feature comprises at least one of:
the volume of the input token;
the amplitude of the input token;
the prevalence of the input token; and
the sustain of the input token.

8. The method of claim 7, wherein:
the volume of the input token comprises a count of related messages for each of the plurality of root messages.

9. The method of claim 7, wherein:
the amplitude of the input token comprises a difference between a count of root messages having at least one related message other than itself and a count of root messages having no related messages other than itself.

10. The method of claim 7, wherein:
the prevalence of the input token comprises a count of the plurality of messages.

11. The method of claim 7, wherein:
the sustain of the input token comprises a sum of the time between each root message and its latest related message.

12. The method of claim 1, wherein determining a score for the input token comprises:
determining a plurality of features of the plurality of root messages and their related messages; and
calculating a weighted sum of the plurality of features.

13. The method of claim 1, further comprising:
receiving a plurality of additional tokens;
determining a score for each of the plurality of additional tokens; and
determining a composite score based on the score of the input token and the scores for each of the plurality of additional input tokens.

14. The method of claim 1, wherein the score for the input token is uniquely associated with the corpus of messages.

15. The method of claim 1, further comprising:
determining a secondary score for the input token based on a secondary corpus of messages, the secondary score for the input token being different than the score for the input token.

16. The method of claim 13, wherein determining a composite score comprises:
determining a mean of the score of the input token and the scores for each of the plurality of additional input tokens;
determining a maximum of the score of the input token and the scores for each of the plurality of additional input tokens;
determining a minimum of the score of the input token and the scores for each of the plurality of additional input tokens; or
determining a standard deviation of the score of the input token and the scores for each of the plurality of additional input tokens.

17. A computer program product for scoring properties of social media postings, the computer program product comprising a computer readable storage medium having program instructions embodied therewith, the program instructions executable by a processor to cause the processor to:
receive an input token;
select from a corpus of messages a plurality of messages, each of the plurality of messages having a publication time and contents, the contents of each of the plurality of messages including the input token;
determine a plurality of root messages from the plurality of messages, each of the plurality of root messages relating to at least one related message, the at least one related message being one of the plurality of messages, each of the plurality of root messages being the earliest message of the corpus of messages related to its at least one related message; and
determine a score for the input token based on the plurality of root messages.

18. The computer program product of claim 17, the program instructions further executable to:
receive a plurality of additional tokens;
determine a score for each of the plurality of additional tokens; and
determine a composite score based on the score of the input token and the scores for each of the plurality of additional input tokens.

19. The computer program product of claim 19, wherein determining a composite score comprises:
determining a mean of the score of the input token and the scores for each of the plurality of additional input tokens;
determining a maximum of the score of the input token and the scores for each of the plurality of additional input tokens;
determining a minimum of the score of the input token and the scores for each of the plurality of additional input tokens; or
determining a standard deviation of the score of the input token and the scores for each of the plurality of additional input tokens.

20. A system comprising:
a device having a processor; and
a process running on the processor, the process being operative to:
receive an input token;
select from a corpus of messages a plurality of messages, each of the plurality of messages having a publication time and contents, the contents of each of the plurality of messages including the input token;
determine a plurality of root messages from the plurality of messages, each of the plurality of root messages relating to at least one related message, the at least one related message being one of the plurality of messages, each of the plurality of root messages being the earliest message of the corpus of messages related to its at least one related message; and
determine a score for the input token based on the plurality of root messages.
